(19) United States
(12) Patent Application Publication
(10) Pub. No.: US 2005/0142926 A1
(43) Pub. Date: Jun. 30, 2005

(54) Fastening device for attaching components & devices

(76) Inventor: Helmut Kahl, (US)

Correspondence Address: FULBRIGHT & JAWORSKI, LLP, 1301 MCKINNEY, SUITE 5100, HOUSTON, TX, 77010-3095, US

(21) Appl. No.: 11/001,451

(22) Filed: Dec. 1, 2004

(30) Foreign Application Priority Data
Dec. 4, 2003 (DE) 20318749.0

(51) Int. Cl. H01R 11/20

(52) U.S. Cl. 439/418

(57) ABSTRACT

A fastening device for attaching components to devices, which comprises at least two members that are joined together in a releasable interlocking manner in angle steps about at least one axis, characterised in that the members are joined by means of an insertion member and the positive interlocking of the connection is achieved by means of external and corresponding internal toothing.

### CROSS-REFERENCE TO RELATED APPLICATIONS

This application claims priority to DE 20318749.0 filed Dec. 4, 2003.

### TECHNICAL FIELD

The invention relates to a fastening device for attaching components to devices, which comprises at least two members that are joined together in a releasable interlocking manner in angle steps about at least one axis.

### BACKGROUND OF THE INVENTION

Fastening devices of this kind for use in manufacturing, testing and measuring are known in a variety of embodiments.

DE 296 03 081 U1 teaches a device of this kind, which is provided with at least one two-armed articulated arm, the joints of the articulated arms being formed by interlocking connections by means of intermeshing members with teeth adapted to one another on the mutually opposing surfaces of the joints and with releasable screw or bolt connections. In this case, the intermeshing members are designed as a kind of serration. A disadvantage seen here is the fact that the production of these intermeshing members together with the articulated arms proves to be difficult, and the design of the articulated arms remains restricted. A further disadvantage is seen in the number of different components.

The problem of the invention thus consists in eliminating the above-mentioned disadvantages and providing further advantages over the state of the art, where simple and versatile use is possible.

This problem is solved in accordance with the invention in that the members are joined by means of an insertion member, and the positive interlocking of the connection is achieved by means of external and corresponding internal toothing.

Advantageous further embodiments of the invention are contained in the dependent claims.

### BRIEF SUMMARY OF THE INVENTION

The fastening device of the invention has an insertion member which is used to join all the members of the device together. This insertion member joins the individual members to one another in an interlocking and releasable manner. It is preferably provided with external toothing, which may be a multi-toothed profile or a notched profile or the like. At the connection points, the members to be joined each possess continuous recesses, which are provided with internal toothing that corresponds to the profile of the external toothing of the insertion member.

The toothing profile of the insertion member and the connection members of the device preferably has an angular pitch of 15°. This is for manufacturing reasons; with appropriate manufacturing processes, it goes without saying that smaller or larger angular pitches can also be implemented. The insertion member is preferably bar stock which can be cut to size in a very simple, advantageous manner for the corresponding connections. It is also conceivable that the insertion member could be manufactured as a sintered product. The insertion member and the connection members of the device consist of a metal, preferably an aluminium alloy.

One advantage is that it is simple to insert internal toothing into the connection members of the device, because they are via holes. The advantage of this is that the design of the connection members is thus not limited.

The multi-toothed profile or notched profile of the connections ensures an interlocking connection. The connection members are fastened to the insertion members by means of different locking members. The locking members are preferably standard elements, such as grub screws, for example. It is also possible to attach known fastening members from the end face of the insertion member, said fastening members fixing the insertion member and the connection member to one another. It is also conceivable for the insertion member and the corresponding connection member to be secured by a pin means.

An advantage of a different embodiment of the invention is that it is possible, with a vernier scale, to obtain smaller angle steps. In one embodiment, for example, this vernier scale has an internal via hole with internal toothing corresponding to the insertion member, while at the same time possessing external toothing which has a different angular pitch from the internal toothing. This external toothing of the vernier scale is then fitted together with corresponding internal toothing of a connection member, further settings being rendered possible by the different angular pitches.

An advantageous aspect is that joining the device of the invention together is simple. For this purpose, it is necessary for each of the connection members to be provided with an insertion member and to be fitted together at the appropriate angle to one another. After that, they are secured by means of suitable locking members. In a further embodiment, the insertion members have a guide journal with an external diameter that is slightly smaller than the internal diameter of the associated internal toothing. This journal arrangement makes it easy for them already to be inserted into one another when releasing the connections between the connection members, or before fitting the connection members together so that they interlock; it is advantageous here for them simply to be aligned towards one another and then pushed together in an interlocking manner once they are aligned.

It is also possible, in addition to the guide journal or instead of the guide journal, to provide the internal toothing of the respective connection member with a hollowed out portion which provides this guidance. In this case, the hollowed out portion has a diameter that is slightly greater than the external diameter of the external toothing of the insertion member. The terms “external diameter” and “internal diameter” used for external toothing and internal toothing correspond to the term “outside diameter of a gearwheel” for internal or external gears.

In addition, an advantage of the device of the invention is that it is possible to fit more than two connection members together by means of one connection. An insertion member can be designed with such a length that it protrudes from both sides of a via hole of a connection member, so that additional connection members can be attached to the protruding ends with the desired angular spacing.

This creates a fastening device for construction elements for attaching to devices, which can be adapted in an advantageous manner before they are pushed together, then fitted so as to interlock, and secured. One advantage is that this is possible with a small number of connection members. It goes without saying that it is also conceivable for the profiling of the insertion members and the associated via holes of the connection members to be produced with different profiles from those described. The profiling of the insertion members and the via holes of the connection members are arranged in the longitudinal direction of the insertion member, or of the via hole in a connection member.

Other known quick-action components can also be used for fastening the connection members to the insertion members.

The invention is not limited to the examples shown.

### BRIEF DESCRIPTION OF THE DRAWINGS

Further details of the invention are described in the drawings by means of schematic representations of working embodiments.

FIG. 1 shows a perspective view of an exemplified fastening device;

FIG. 2 shows a perspective view of a further embodiment of a fastening device;

FIG. 3 shows a perspective view of a base element of a fastening device; and

FIG. 4 shows a schematic view of a vernier disk.

### DETAILED DESCRIPTION OF THE INVENTION

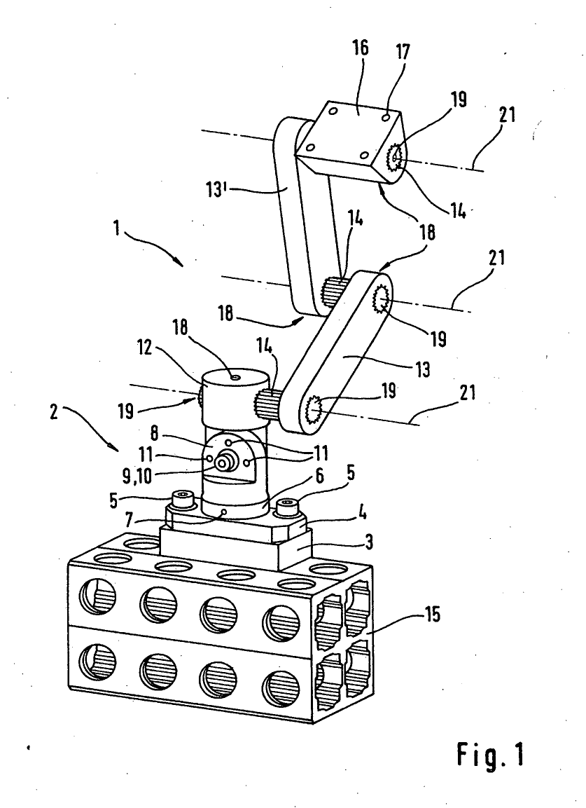

FIG. 1 shows a perspective view of an exemplified fastening device 1, which is attached by fixing bolts 5 to a device 15 by means of an adapter plate 3 and a foot plate 4.

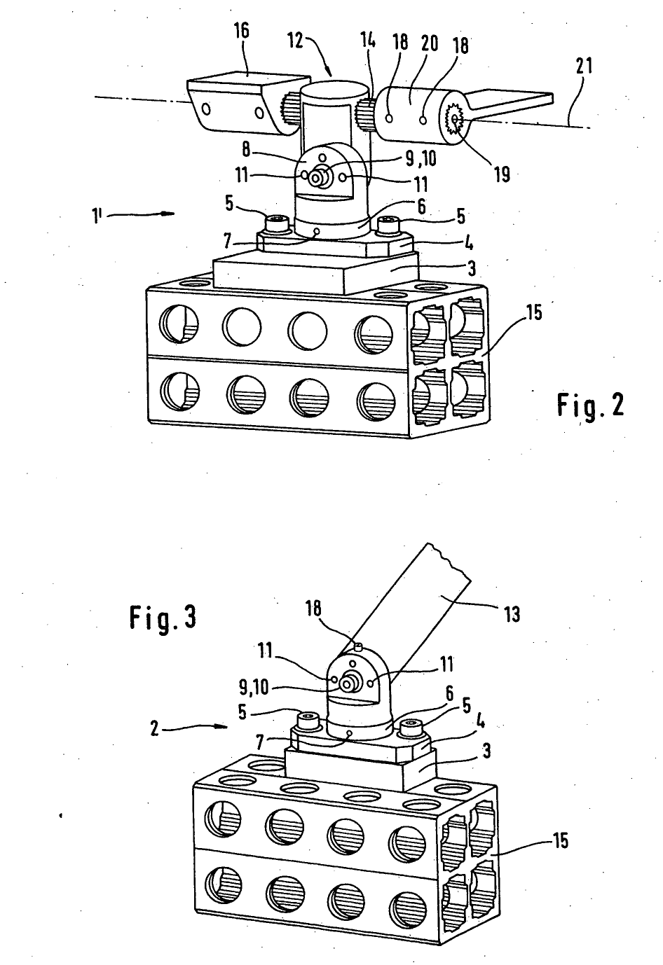

A link support 8, which can rotate about a vertical longitudinal axis and can be fixed in place by means of a locking member 7, is disposed on the foot plate 4 by means of a rotatable swing plate 6. The adapter plate 3, the foot plate 4, the rotatable swing plate 6 and the link support 8 together form a base element 2, which is also shown in FIG. 2 and FIG. 3.

FIG. 1 shows that, attached to the link support 8 of the base element 2, there is a mounting head 12 which can be swung about a lateral axis perpendicular to the longitudinal axis of the link support 8 and can be fixed in place by means of locking screws 11. In its upper portion, the mounting head 12 has a continuous recess, into which an insertion member 14 is inserted which is extended on one side. The insertion member 14 and the corresponding continuous opening of the mounting head 12 have profiling which creates a positive interlocking fit between the mounting head 12 and the insertion member 14. Attached to the protruding end of the insertion member 14 is a connection member 13. In this embodiment, this connection member is straight and elongate in shape and has, at each end, a profiled continuous opening, the profile of which is formed so as to correspond to that of the insertion member 14.

A further connection member 13′, is attached to the upper end of the connection member 13 by means of the insertion member 14 already described. At the upper end of this connection member 13, there is likewise an inserted insertion member 14, onto which is pushed an assembly member 16 with fastening holes 17.

The connections between the mounting head and the connection member 13 and between the latter and the connection member 13′, and also between the latter and the assembly member 17 each form an axis 21, about which the members forming the respective connection can be swivelled after being detached from the respective profiled insertion member 14 and fitted together again.

The insertion member 14 and the corresponding receiving apertures in the individual connection members 13, 13′, and also in the assembly member 16 and in the mounting head 12, and indeed also in any other connection members, not shown, are in each case releasably connected about the axis 21 in angle steps so as to interlock. In a preferred embodiment, the insertion member 14 has a multi-toothed profile of external toothing, which is designed to run parallel to the longitudinal axis of the insertion member 14. This multi-toothed profile may also be a standardised notched profile. The respective receiving apertures of the connection members 13, 13′, of the mounting head 12 and the assembly member 16 have internal toothing corresponding to this profile.

The pitch of this multi-toothed or notched profile is preferably 15° and is dependent on the manufacturing process used for that profile. It is conceivable that smaller angular pitches can be produced by other manufacturing processes, such as sintering.

In FIG. 1, the connection members 13 and 13′ are depicted with a certain spacing between them and towards the mounting head 12. In this case, this is only to make the respective insertion member clear. In practice, these parts are all joined together closely. In a preferred embodiment, the connection members 13, 13′, the assembly member 16 and the mounting head 12 with the respective insertion member 14 are locked in place by means of a first locking member 18, such as a locking screw or grub screw. Other locking possibilities are also conceivable, such as a second locking member 19, which can be disposed on the end face of the insertion member 14 in the form of a fastening member.

In addition, it is possible to design the second locking member in the form of a locking bore with pin means or screw fitting on the end face of the insertion member between the latter and the corresponding member of the respective connection.

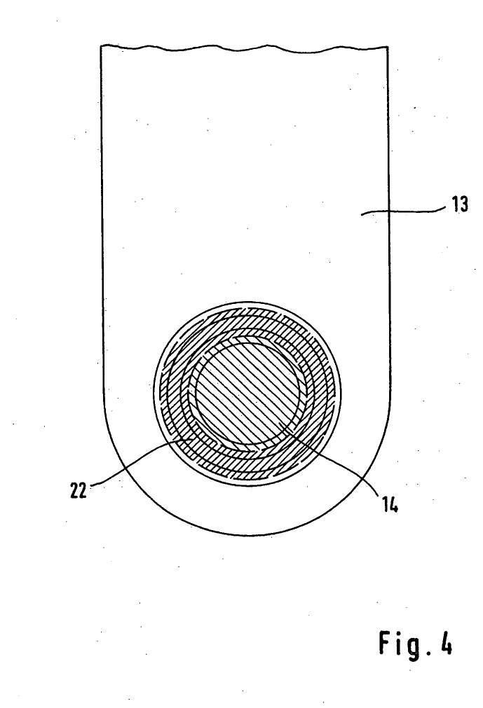

In order to obtain a finer angular pitch between the members, a vernier scale 22 is disposed between the insertion member 14 and a connection member in a further embodiment. This arrangement is shown in FIG. 4 in a schematic view from above. The vernier scale 22 can be designed in different forms. Its principle consists in the fact that, for example, different angular pitches are provided between its internal toothing and its external toothing. For this purpose, it is necessary that the connection member with the internal toothing be adapted to the angular pitch of the external toothing of the vernier scale 22. Further variations of the different angular pitch are of course conceivable.

In one embodiment, which is not shown, the insertion member 14 has a guide journal, the external diameter of which is the same as the outside gearwheel diameter of the internal toothing of the associated connection member. The length of this guide journal runs in the longitudinal direction of the longitudinal axis of the insertion member 14 and can be of different lengths, depending on the system. The task of the guide journal is to guide the connection members, which are joined via the insertion member 14, when they are pulled apart or joined together, so that, as an advantage, it is possible to swing the connection members towards one another without their having to be held in front of one another for guidance for the adaptation process. It is also conceivable that the connection member with the internal toothing should have a hollowed out portion in the direction of the axis of the internal toothing, the internal diameter of the hollowed out portion corresponding to the outside gearwheel diameter of the external toothing of the insertion member 14. It is advantageous for the external diameter of the guide journal and the internal diameter of this hollowed out guidance portion to be selected with such dimensions that the corresponding part can be inserted and swivelled easily.

FIG. 2 shows a further embodiment of a fastening device, the mounting head 12 being equipped with an insertion member 14 which protrudes on both sides of the mounting head 12 and thus provides possibilities for sliding on an assembly member 16 and a further assembly member 20. Similarly, instead of an assembly member 16, 20, a further connection member 13 with corresponding extensions and further connection members can be attached. The assembly members 16, 20 serve to attach different components such as measuring means, detent members or fastening devices or the like.

The base element 2 can also be inserted in such a way that—as shown in FIG. 3—a connection member 13 can be attached by means of a simple locking screw 10 and further locking screws 11. Instead of the locking screw 10, it is likewise conceivable to use an insertion member 14 with the appropriate corresponding retainers. The link support 8 of the base element 2 can be swivelled about its longitudinal axis with a simple known revolving joint disposed in the rotatable swing plate 6 and secured by means of the locking member 7. Here too, it is likewise possible to use an insertion member 14 with a corresponding receiving means in the foot plate 4.

The insertion members 14 can advantageously be produced as bar stock, for example, which can advantageously be cut to the appropriate dimensions in a very simple manner.

In this way, an advantageous versatile fastening device for attaching different components to devices can be made, which is extremely simple to fit together and lock in place. Furthermore, this device in accordance with the invention is particularly economical in terms of manufacturing and processing the individual parts, in which the connection members 13, 13′ can be designed not only in the straight embodiment shown, but also in a cranked or twisted or other conceivable embodiment.

1. A fastening device for attaching components to devices, which comprises at least two members that are joined together in a releasable interlocking manner in angle steps about at least one axis wherein the members are joined by means of an insertion member, and the positive interlocking of the connection is achieved by means of external and corresponding internal toothing.

2. The fastening device as claimed in claim 1, wherein the external and internal toothing is designed as a multi-toothed profile or a notched profile parallel running to the longitudinal axis of the insertion member, the longitudinal axis forming the axis.

3. The fastening device as claimed in claim 1, wherein the insertion member is in each case locked in position relative to a connection member, a mounting head or an assembly member by means of a locking member.

4. The fastening device as claimed in claim 3, wherein a first locking member is a grub screw arranged in the member of the respective connection with internal toothing.

5. The fastening device as claimed in claim 3, wherein a second locking member in the form of a fastening member is arranged on the end face of the insertion member.

6. The fastening device as claimed in claim 3, wherein a second locking member in the form of a locking bore with pin means or a screw fitting on the end face of the insertion member is formed between the latter and the corresponding member of the respective connection.

7. The fastening device as claimed in claim 1, wherein a vernier scale is provided between an insertion member and a corresponding member of the connection, which has different angular pitches between its internal toothing and its external toothing, and wherein the associated insertion member and the associated member of the connection each have a corresponding angular pitch.

8. The fastening device as claimed in claim 1, wherein the member carrying the external toothing has a guide journal with an external diameter that is slightly smaller than the outside gearwheel diameter of the internal toothing of the corresponding member.

9. The fastening device as claimed in claim 1, wherein the member carrying the internal toothing has a hollowed out portion the internal diameter of which is slightly greater than the outside gearwheel diameter of the external toothing of the corresponding member.
